(19) United States
(12) Patent Application Publication
(10) Pub. No.: US 2025/0282081 A1
(43) Pub. Date: Sep. 11, 2025

(54) Method for manufacturing a drill segment, drill segment, and drill bit

(71) Applicant: Hilti Aktiengesellschaft, Schaan (LI)

(72) Inventors: Carsten PETERS, Sax (CH); Jens STRACKE, München (DE); Chafic ABU ANTOUN, Buchs (CH); Thorsten KLEIN, Balgach (CH); Franz MANDL, Feldkirch (AT); Steven MOSELEY, Nenzing-Gurtis (CH); Konrad WEGENER, Göppingen (DE); Michael KUFFA, Zürich (CH); Stefan FABBRO, Gams (CH); Lucas MARRA ARAUJO, Schlieren (CH)

(21) Appl. No.: 18/858,929

(22) PCT Filed: May 3, 2023
(86) PCT No.: PCT/EP2023/061709

§ 371 Date: Oct. 22, 2024

(30) Foreign Application Priority Data
May 11, 2022 (EP) 22172695.3

(51) Int. Cl. B28D 1/04; G06F 30/27; G06F 119/14

(52) U.S. Cl. CPC B28D 1/041; G06F 30/27; G06F 2119/14

(57) ABSTRACT

A method for manufacturing a drill segment for a drill bit, in particular for a drill bit for machining reinforced concrete, wherein the drill segment has at least one layer with a multiplicity of abrasive particles, wherein the abrasive particles form a pattern within the layer. The method includes at least one performance parameter of the drill segment that has the pattern precalculated and/or the pattern is determined according to a precalculation of the performance parameter, and, in particular if the performance parameter attains or exceeds a particular value, a drill segment that has at least one layer with abrasive particles arranged in accordance with the pattern is manufactured. A drill segment and to a drill bit. It is possible to quickly and inexpensively develop and manufacture particularly high-performance drill segments for drill bits.

The invention proceeds from a method for manufacturing a drill segment for a drill bit, wherein the drill segment has at least one layer with a multiplicity of abrasive particles, wherein the abrasive particles form a pattern within the layer.

### BACKGROUND

Performance parameters, such as service life and drilling performance, of drill segments equipped with abrasive particles, such as diamond drill segments, can be significantly determined by the arrangement of the abrasive particles, in particular diamonds, contained therein.

### SUMMARY OF THE INVENTION

Finding drill segments with favourable performance parameters is however often difficult, in particular if it is necessary to optimize for several performance parameters. Relationships between different performance parameters, and the design of the pattern, are often highly complex, such that, with conventional development, it has been necessary to perform numerous test series with correspondingly unfavourable expenditure of time and costs, and it has nevertheless remained uncertain whether a tested drill segment actually exhibits improved and more efficient performance parameters.

It is an object of the present invention to specify a method for rapidly and inexpensively manufacturing, in particular developing, a drill segment, and to specify an inexpensive drill segment for a drill bit, which drill segment allows core drilling with particularly good performance parameters.

The present invention provides a method for manufacturing a drill segment for a drill bit, wherein the drill segment has at least one layer with a multiplicity of abrasive particles, wherein the abrasive particles form a pattern within the layer, wherein, firstly, at least one performance parameter of the drill segment that has the pattern is precalculated and/or the pattern is determined according to a precalculation of the performance parameter, and a drill segment that has at least one layer with abrasive particles arranged in accordance with the pattern is manufactured.

In particular, the drill segment that has the pattern may be manufactured if the performance parameter attains or exceeds a particular value.

It is thus conceivable that at least one drill segment to be manufactured is selected, on the basis of the performance parameter, from several possible patterns and/or drill segments having such patterns.

Here, the layer may also be physically distinguishable and/or separable from adjacent regions of the drill segment. The layer may alternatively also be merely virtual; it may for example be a section plane.

The layer may be planar. It may however also be non-planar. In particular, in a fully manufactured drill segment, the layer may extend in a non-planar manner, in particular so as to be deformed out of a plane.

Through the precalculation of the performance parameter, it is possible for laborious test series with individually manufactured drill segments, and subsequent measurement of the performance parameter, to be dispensed with. Costs and/or time can thus be saved. Risks associated with carrying out the test series can be reduced or eliminated entirely.

The pattern may have at least two identical or at least substantially identical, mutually spaced sub-regions. In particular, a particle-free region, which may for example be rectangular, may be situated between the two sub-regions. This can improve the performance parameter, for example the abrasive removal performance and/or wearing behavior of the drill segment.

The precalculation may take into consideration a behavior and/or a change of at least one particle, of the pattern and/or of the drill segment. It may be based generally on features of the drill segment or of a part thereof. Alternatively or in addition, a change of a workpiece which is to be machined by the drill segment and which is formed from at least one material may also be precalculated. For example, a cutting depth, a depth of abrasive removal per rotation, an abrasion, a deformation or the like may be precalculated.

Here, the workpiece which is based on the precalculation, and/or which is to be machined, may have at least two materials, in particular a stone, for example a stone composed of at least two different base substances, and a metal. It may for example comprise reinforced, in particular steel-reinforced, concrete. If the workpiece has multiple materials, in particular if dedicated test series would be necessary for each of the materials, the precalculations can result in a particularly comprehensive reduction of the expenditure of time and/or costs.

In general, the precalculation may thus be performed on the basis of a physical model. The physical model may at least approximately replicate physical and/or chemical principles.

In particular if it is intended to precalculate performance parameters for a multiplicity of patterns, the following approach is expedient:

Firstly, performance parameters are precalculated for a limited number of desired patterns, for example on the basis of a physical model and/or on the basis of prior measurement results.

A fitted model can subsequently be trained using the data obtained. The fitted model may for example have a machine learning module.

The machine learning module may then be trained on the basis of the pattern and the resulting performance parameters. Here, the training may be performed on the basis of experimentally obtained data, on the basis of data obtained using the physical model, and/or on the basis of a combination of such data sources.

Further performance parameters for further patterns may subsequently be precalculated by means of the fitted model or the—now trained—machine learning module.

The machine learning module may for example be and/or have a module for performing probabilistic, in particular linear, regressions. Owing to the probabilistic nature of the module, it is also possible for statistical effects, for example an individual situation of the abrasive particles, to be at least partially taken into consideration.

With the above-described variants of the method, it is thus possible to arrive at performance parameters on the basis of particular patterns, and to rank the patterns on the basis of the performance parameters.

In one class of method, provision may be made for an optimum of the performance parameter, and/or a pattern associated with the optimum of the performance parameter, to be determined on the basis of an optimization calculation. It is thus possible to seek an optimized performance parameter and to derive a pattern associated therewith.

The optimization calculation may be performed on the basis of the physical model. Calculations on the basis of a physical model can be highly computationally intensive. Performing the optimization calculation on the basis of the fitted model can thus greatly speed up the process and considerably lower the resource requirements.

The optimization calculation may be configured to seek a global optimum. It may for example use a genetic algorithm and/or a particle swarm.

The optimization calculation may take boundary conditions into account.

A domain adaptation may be performed, for example on the basis of simulation data obtained in particular from the precalculation, and/or on the basis of experimentally obtained data.

If a drill bit which is expedient with regard to the performance parameter has been identified following the approaches above, the drill segment having the pattern can be produced in physical form. For this purpose, it is possible for multiple, in particular similar, layers to be stacked one on top of the other. In particular, it is conceivable that, in one step, multiple layers are lined up together, in particular stacked, in order to form the drill segment or a green body of the drill segment. A drill segment can then be manufactured by virtue of layers of the identical or at least substantially identical pattern being formed and/or arranged in layered, stacked form. The drill segment may subsequently be heat-treated, for example sintered. It may be pressurized, for example by hot isotropic pressing.

The stacking may be performed congruently, but it is also possible for at least one layer to be arranged and/or formed so as to be offset with respect to an adjacent layer; a resulting layer structure may extend in non-planar fashion, in particular after a pressing operation.

With regard to the performance parameter, it is conceivable for this to comprise at least one wear parameter.

It is alternatively or additionally conceivable for the at least one performance parameter to comprise a cutting performance parameter.

Drill segments and the method for manufacturing such a drill segment may be of particular interest if the abrasive particles have carbon, in particular diamond, graphene and/or carbon nanotubes, for example in the form of aggregated diamond nanorods and/or graphene, tungsten carbide, tungsten boride and/or a boron nitride. The drill segment may thus in particular be a diamond drill segment.

The scope of the invention furthermore encompasses a drill segment manufactured in accordance with the method described above. The drill segment may be configured for use on a drill bit.

It may have a binder material. The abrasive particles may be embedded in the binder material. The binder material may at least partially surround the abrasive particles.

The binder material may have a lower hardness and/or a lower breaking strength than the material of the abrasive particles.

The drill segment, in particular the binder material, may be pressure-treated and/or heat-treated. It may in particular be and/or comprise a sintered body.

The drill segment may be cuboidal or at least substantially cuboidal. It may alternatively be of cylinder segment shape or at least substantially of cylinder segment shape. Here, “substantially” may also encompass situations in which fewer than half of the sides of the drill segment deviate from the respective basic shape, that is to say cuboidal shape or cylinder segment shape. For example, a side with which the drill segment is primarily intended to come into contact with a workpiece may have an elevation. The elevation may for example form a cutting edge of the drill segment.

The drill segment may have a layer structure. Abrasive particles may be arranged within a layer. The arrangement of the abrasive particles within the layer may form a pattern. Adjacent layers may have the same pattern. Adjacent layers may be arranged congruently or—alternatively and particularly preferably—so as to be offset with respect to one another.

The layers may extend in deformed, in particular non-planar fashion.

Substantially constant cutting performance can be achieved if corresponding abrasive particles in at least two layers having the same pattern have the same orientation or situation.

Particularly inexpensive manufacturing is possible if the abrasive particles are arranged arbitrarily, in particular in a random configuration.

The drill segments, in particular the layers, may be formed in layered fashion by means of in particular individually filled molds.

In the drill segment, the abrasive particles in at least one layer may be configured in accordance with a pattern composed of at least two mutually spaced sub-regions. The at least two sub-regions may have identical sub-patterns, each formed from abrasive particles belonging to the respective subregion.

At least one of the subregions may have at least one polygonal, in particular triangular and/or tetragonal, arrangement of abrasive particles. Such a subregion can give rise to a particularly good balance between durability and cutting performance of the drill segment.

The scope of the invention furthermore encompasses a drill bit.

The drill bit comprises a preferably tubular shaft, at one end of which there is arranged and/or formed a connecting portion for connecting the drill bit to a power tool. At least one of the above-described drill segments is arranged and/or formed at the other end of said shaft.

The scope of the invention furthermore encompasses a computer program product. The computer program product may comprise a memory. Program code that can be executed on a computer unit may be retrievably stored in the memory. The computer program product, in particular the program code, may be configured to implement the method described above and/or below or at least a part of the method described above and/or below, in particular to implement one or more of the above-describe features of the physical and/or fitted model. In particular, the computer program product may be configured to precalculate at least one performance parameter of a drill segment that has a pattern, and/or to determine the pattern according to a precalculation of the performance parameter. The computer program product may also be configured to manufacture a drill segment that has at least one layer having the pattern of correspondingly arranged abrasive particles, and/or to control the manufacture of such a drill segment, in particular if the performance parameter attains or exceeds a particular value.

Further features and advantages of the invention are apparent from the detailed description of working examples of the invention that follows, with reference to the figures of the drawing which shows details essential to the invention, and from the claims. The features shown therein should not necessarily be considered to be true to scale and are illustrated in such a manner that the special features according to the invention can be clearly visualized. The various features can be implemented individually in their own right or collectively in any combinations in variants of the invention.

Working examples of the invention are illustrated in the schematic drawing and elucidated in detail in the description that follows.

### BRIEF DESCRIPTION OF THE DRAWINGS

The figures show:

FIG. 1 a drill bit in a schematic side view;

FIG. 2 a detail of a drill bit having multiple drill segments in a perspective oblique view;

FIG. 3 a flowchart of a method for manufacturing a drill segment;

FIG. 4 a partial aspect of a variant of the method according to FIG. 3;

FIG. 5 a schematic illustration of physical model;

FIG. 6 a schematic illustration of a segment model;

FIG. 7a-d images of abrasive particle wear types that are taken into consideration;

FIG. 8 an overview of abrasive particle geometries that are taken into consideration;

FIG. 9a-b the determination of a cutting profile and associated cutting action;

FIG. 10a-b perspective illustrations of workpieces, and determined cutting contours;

FIG. 11 a pattern; and

FIG. 12 a diagram relating to a performance parameter.

### DETAILED DESCRIPTION

In the description of the figures that follows, comprehension of the invention is facilitated by use of the same reference numerals in each case for identical or functionally corresponding elements.

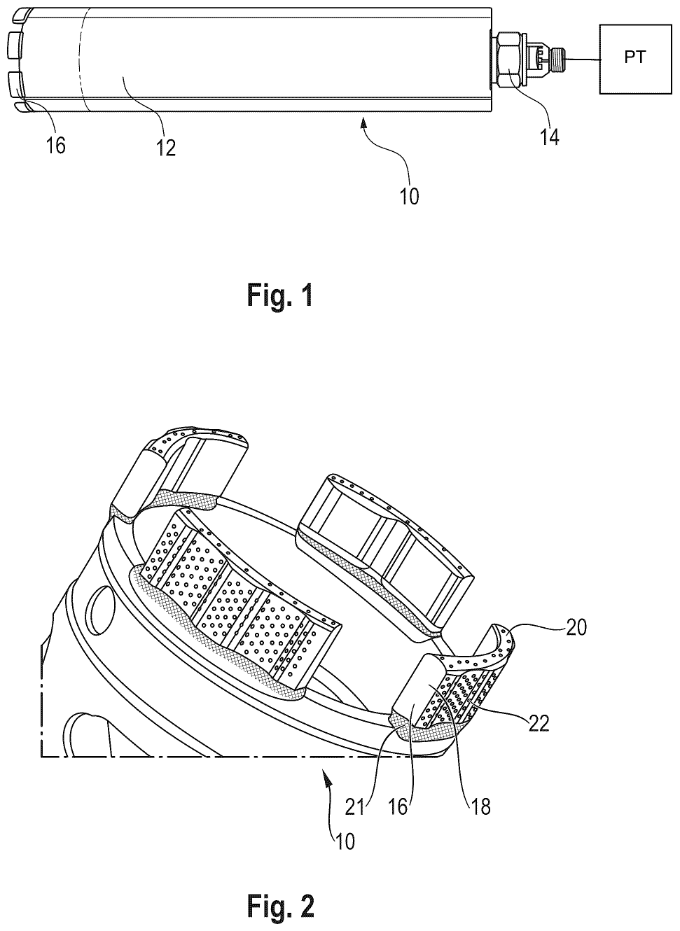

FIG. 1 shows a drill bit 10, comprising a tubular shaft 12, at one end of which there is formed a connecting portion 14 for connecting the drill bit 10 to a power tool (illustrated solely schematically as PT in FIG. 1). Situated at the other end of said shaft is a multiplicity of drill segments 16, of which only one is denoted by a reference designation for the sake of simplicity. The drill segments 16 may be welded or brazed onto the shaft 12.

FIG. 2 shows a detail of a drill bit 10 in a perspective illustration. The drill bit 10 has multiple drill segments 16, of which one is denoted by a reference designation by way of example. The drill segments 16 are substantially of cylinder segment shape. They have cutting edges 20. The drill segments 16 are welded onto the rest of the drill bit 10 along weld seams 21. In order to improve the weld characteristics of the drill segment 16, the drill segments 16 have no abrasive particles 22, or at least a reduced density of abrasive particles 22, in the vicinity of the weld seams 21.

The drill segments 16 have a binder material 18 into which a multiplicity of abrasive particles 22 is embedded in each case. For simplicity, only one of the abrasive particles 22 is denoted by a reference designation.

The binder material 18 may have a copper-based and/or an iron-based alloy. The abrasive particles 22 are diamond particles.

The drill segment 16 has a layer structure. In particular, the abrasive particles 22 are arranged within layers in the drill segment 16. The respective abrasive particles 22 form a pattern within each of the respective layers.

The drill segment 16 has been manufactured in accordance with the method described below.

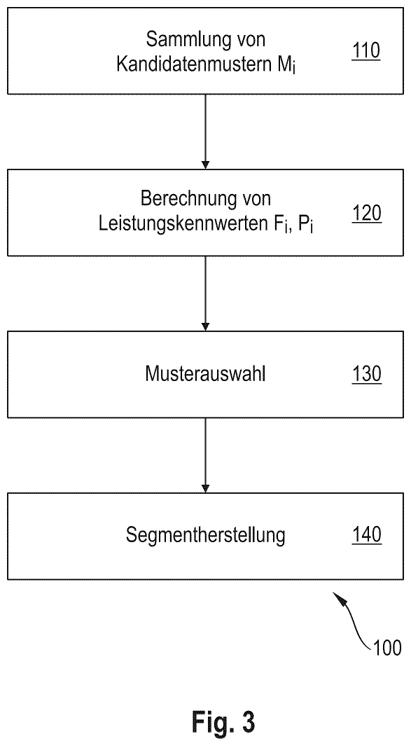

FIG. 3 shows a method 100 for manufacturing the drill segment 16. For the description of the method, it should be understood here and below that the drill segment 16 is intended to be configured to cut a material that is composed of multiple components, in particular reinforced concrete. For this purpose, it is intended for the drill segment 16 to be optimized with regard to the performance parameters of pressing force F and required mechanical power P. Here, one optimization variable consists in the design and/or selection of the pattern generated by the abrasive particles 22.

Firstly, in a candidate phase 110, several patterns Mᵢ for examination are compiled as test candidates.

In a precalculation phase 120, for each of the test candidate patterns Mᵢ of the drill segment 16 that is to be created, the performance parameters Fᵢ and Pᵢ of the pattern are precalculated.

In a selection phase 130, the one or more test candidate patterns Mᵢ that have the best performance parameters Fᵢ and Pᵢ are identified and selected as result patterns.

In a production phase 140, drill segments 16 are then manufactured in which at least one layer, preferably all layers, has/have at least one of the result patterns selected in the preceding phase 130.

For this purpose, a green body may firstly be manufactured. The green body may be constructed in layers by means of a mold. For this purpose, the mold may have recesses in an arrangement corresponding to the respectively desired result pattern. Diamonds as abrasive particles 22 may be inserted into said recesses. If the result pattern specifies an orientation of the abrasive particles 22, this may be taken into consideration when inserting the diamonds. Subsequently, the mold and thus the abrasive particles 22 may be applied to or introduced into the layer with binder material 18 in order to place the abrasive particles 22 in the layer in accordance with the result pattern. After a desired number of layers has been built up, the green body may be pressed, heated and/or sintered as required.

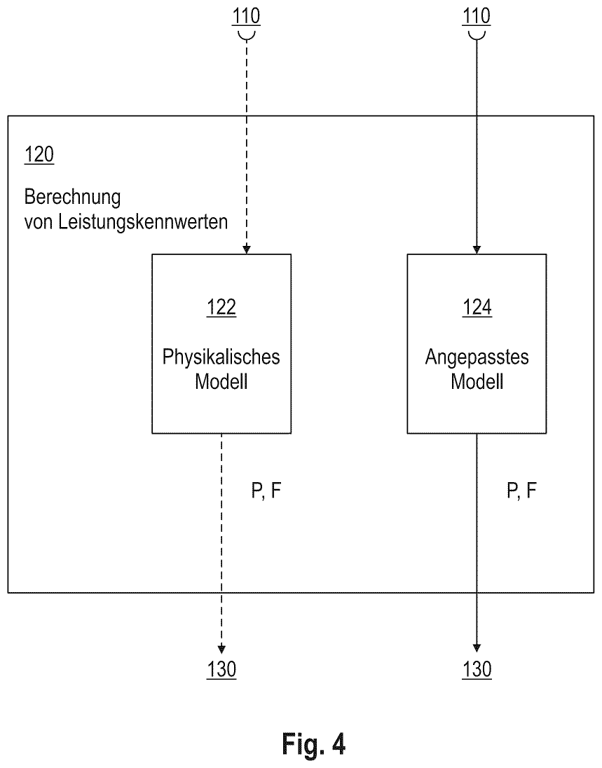

As is illustrated in FIG. 4 schematically and by means of dashed arrows, the precalculation in the precalculation phase 120 may be performed on the basis of a physical model 122.

The physical model 122 may take into consideration one or more individual factors that influence the performance parameters F, P that are to be precalculated, and may suitably combine these individual factors in order to derive the desired performance parameters F, P therefrom.

Owing to the high number of abrasive particles 22 and the multiplicity of possible arrangements for the abrasive particles 22 and thus the high number of degrees of freedom for the pattern Mᵢ, the determination of the performance parameters F, P of all candidate patterns Mᵢ can however in some cases involve considerable computational effort.

In order to nevertheless be able to examine a particularly large number of candidate patterns Mᵢ and in order to minimize the computing capacity required for this purpose, the precalculations for the candidate patterns Mᵢ may for simplicity also be performed using a fitted model 124 instead of the physical model 122.

The fitted model 124 may preferably be trainable; it may then be taught by means of the physical model 122.

For this purpose, the fitted model 124 may for example comprise a probabilistic regression, such that, after the fitted model 124 has been calibrated, precalculations can be performed significantly more quickly and in particular with less computational effort. Further trainable models, based for example on neural networks such as deep learning modules or the like, are alternatively or additionally also conceivable. The trainable models may be linear or non-linear.

By means of a probabilistic configuration of the regression, a stochastic distribution of particular characteristics of the layers or patterns Mᵢ can be taken into consideration. For example, in the case of a pattern M; that does not define a particular orientation of the abrasive particles 22, such that the abrasive particles 22 assume orientations in a randomly distributed manner, these orientations of the abrasive particles 22 are based on a corresponding stochastic distribution.

To calibrate the fitted model 124, the performance parameters F, P are determined firstly for a sample of the candidate patterns Mᵢ by means of the physical model 122. With the candidate patterns Mᵢ as input data and with the performance parameters F, P that are obtained, it is then possible to calculate regression coefficients and/or further model parameters that are required for the fitted model 124, and thus to calibrate the fitted model 124.

Performance values of all other candidate patterns Mᵢ can then be estimated with less computational effort by means of the calibrated fitted model 124, such that the computational effort can be reduced by a factor of 10 or more.

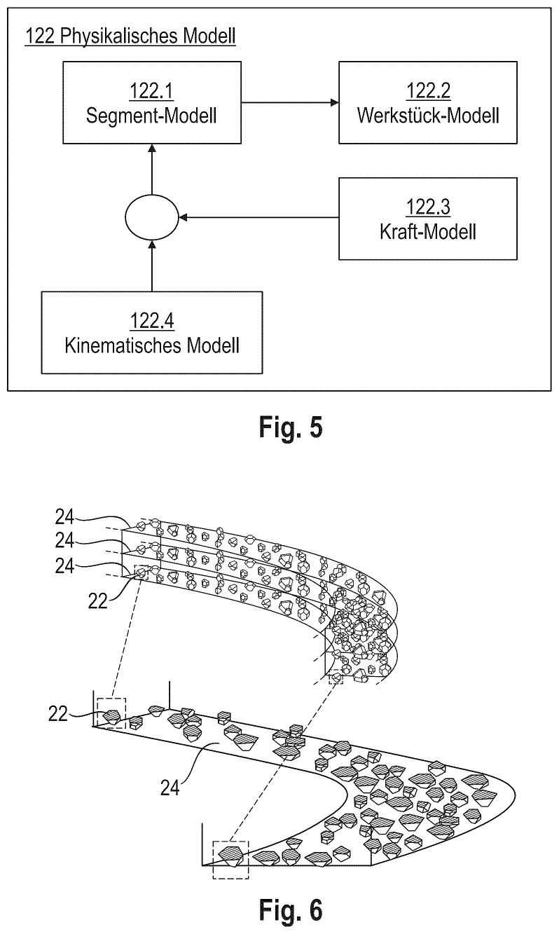

FIG. 5 schematically shows details of the physical model 122. Said physical model comprises a drill segment model 122.1, a workpiece model 122.2, a processing force model 122.3, and a kinematic model 122.4. These models 122.1, 122.2, 122.3 and 122.4 interact with one another.

It is possible here to use stochastic and/or deterministic variables.

The exemplary embodiment will be described on the basis of reinforced concrete, and thus concrete, that is to say cement and agglomerates, in conjunction with a steel reinforcement, as material of the workpiece.

Force F and input power P are determined as performance parameters. It is also conceivable to determine other performance parameters, in particular an abrasively removed material quantity, the surface profile, cutting and/or normal forces, wear parameters and/or the like.

The drill segment model 122.1 provides a detailed geometric description of the drill segment 16 equipped with abrasive particles, and in particular of one of its layers. The kinematic model 122.4 adds kinematic data to this, such that it is possible to calculate interactions between the abrasive particles 22 and the workpiece material, and thus changes to the workpiece surface. Building on this, forces can be calculated by means of the processing force model 122.3, thus respectively completing a calculation loop. The forces can in turn be fed into the kinematic model 122.4, and the calculation process started anew.

One simplification for reducing the computational effort may consist in only a single drill segment 16 being precalculated for a drill bit 10. Then, if required, the total performance of the drill bit 10 can be extrapolated based on the actual number of drill segments 16.

### Drill Segment Model 122.1

The drill segment model 122.1 models the form of the drill segment 16 and in particular of its abrasive particles 22.

In principle, a multiplicity of layers, as illustrated in the upper half of FIG. 6, may be replicated in the drill segment model 122.1. By way of example, three layers 24 of a drill segment 16 (FIG. 1) are illustrated in the upper half of FIG. 6.

In a preferred alternative, to further simplify and minimize the computational effort, only one layer 24 (see the lower half of FIG. 6) is modeled. In particular, for this purpose, an outermost layer 24, which comes into contact with the workpiece and thus functions in particular as a cutting layer, is modeled.

Aside from the positions and orientations of the abrasive particles 22, of which, in FIG. 6, one is denoted by a reference designation in each of the upper half and the lower half of FIG. 6 by way of example, the modeling may also include their sizes, mechanical parameters such as critical compressive strength, shapes, degrees of wear, wear types and/or the like.

Within the layer 24, the abrasive particles 22, in this case diamonds, may be arranged in accordance with the pattern Mi. For example, between 10 and 100, for example 25 or 50, abrasive particles 22 may be arranged in a layer.

Here, variations as regards the extent to which the individual abrasive particles 22 project out of the layer 24 or out of the surface of the drill segment, for example in the range of up to approximately 150 μm, may be taken into consideration.

If the pattern Mᵢ provides a random distribution of the orientations of the abrasive particles 22, the orientations may be taken into consideration as stochastically distributed, for example normally distributed, three-dimensional angles.

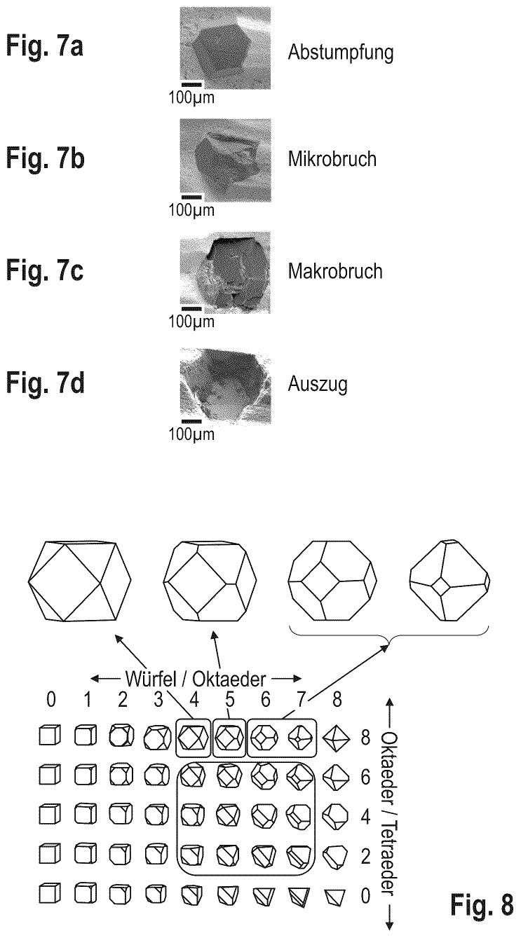

In the lower half of FIG. 6, it can also be seen that a degree of particle wear and/or a state of particle wear can be modeled for each individual abrasive particle 22. Wear types that are taken into consideration may for example include abrasive dulling (FIG. 7a), microfracture (FIG. 7b), macrofracture (FIG. 7c) and particle pull-out from the binder material (FIG. 7d).

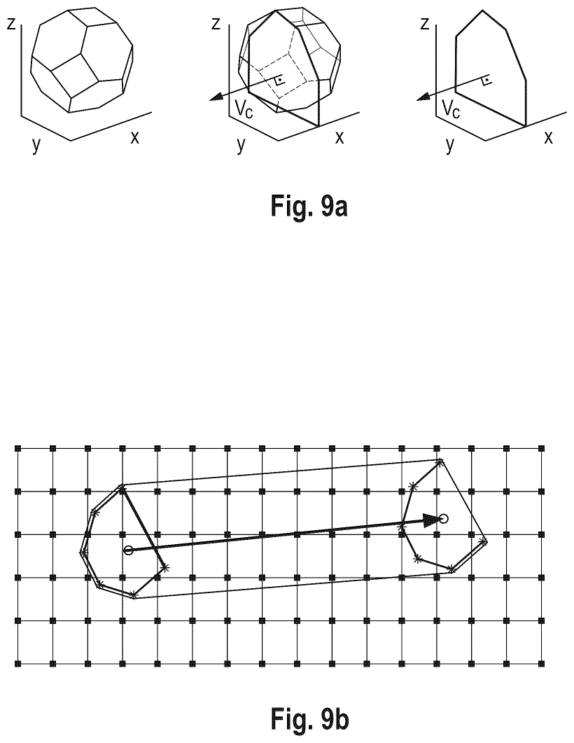

The drill segment model 122.1 may also allow for different initial shapes of the abrasive particles 22 to be taken into consideration. In the case of diamond abrasive particles 22, FIG. 8 shows examples of such initial shapes in this regard.

Provision may furthermore be made for the sizes of the abrasive particles 22 to be modeled in the drill segment model 122.1 in order to thus reflect the fact that, in the case of the common selection method involving screening, these sizes are to be expected to exhibit a certain degree of variation. It is preferably also possible for the size and/or a critical compressive strength distribution of the abrasive particles 22 to be modeled as a stochastic, for example normally distributed, variable.

Furthermore, the model may take into consideration the fact that certain inaccuracies arise even when using placement methods for positioning the abrasive particles 22. It is thus also possible for the position and/or a deviation in relation to a setpoint position to be modeled as a stochastic variable.

### Wear of the Drill Segment 16

To model the wear of the drill segment 16, analogously to FIG. 7a to FIG. 7d, the four different wear types or degrees of wear mentioned in this regard are modeled.

Abrasive dulling may be modeled as follows:

$$\frac{dW}{dt} = K \cdot {F}_{c} ( t ) \cdot {v}_{c} \cdot {e}^{- \frac{B}{{T}_{grind}}}$$

Here, dW/dt is a rate of wear, for example in [mm/s], K is a wear coefficient, B is a dimensionless constant from the Arrhenius equation and takes into consideration the activation energy and the universal gas constant, F_{c} is a cutting force, v_{c} is a cutting rate, and T_{grind} is a temperature in the cutting region.

Microfracture and macrofracture are modeled similarly to one another, wherein the two fracture types may differ primarily with regard to a penetration depth.

Fracture arises if the resultant stress acting on the abrasive particle 22 is higher than its inherent compressive strength. A failure-induced stress for brittle materials without elastic deformation can be modeled as follows:

$${σ}_{1} = \frac{( {σ}_{T} + {σ}_{N} ) + \sqrt{{( {σ}_{T} - {σ}_{N} )}^{2} + 4 {τ}^{2}}}{2} ,$$

where σ_{N} is a normal stress, calculated as:

$${σ}_{N} = \frac{{F}_{N}}{{A}_{⊥}}$$

with F_{N} as a normal force and A₁ as a projected area or cutting area orthogonal with respect to the cutting direction (see also further below with regard to FIG. 9a).

σₜ corresponds to a stress in a cutting direction, which can be modeled as:

$${σ}_{T} = \frac{{F}_{c}}{{A}_{cut}}$$

where F_{c} is the cutting force and A_{cut} is a particle cross section orthogonal with respect to the cutting direction.

T_{yz} corresponds to the shear stress in the abrasive particle and is represented by:

$${τ}_{yz} = \frac{{F}_{c}}{{A}_{⊥}}$$

The direction in which the fracture propagates is stochastically defined according to the cutting depth of the particle 22 or of the diamond. As soon as the points of the orthogonal plane for the fracture generation have been defined, the modeled fracture generation takes place in a 2D plane (orthogonal to the plane in the cutting direction, FIG. 9a), resulting in a new abrasive particle geometry and, as a further consequence, a new projected area.

For the modeling of the particle pull-out, a distinction can be made between two cases.

If, after a fracture of the particle 22 or owing to abrasive wear, the cutting profile is reduced to 30% in relation to an intact profile, the reduction in the contact area between the binder material and the surface of the particle 22 results in a pull-out.

The second case takes into consideration wear of the binder material. For this purpose, a rate of wear of the binder material can be estimated. This influences the threshold or critical force at which the abrasive particle 22 breaks away. This can be modeled as follows:

$$Q = \frac{{K}_{m c} \cdot N \cdot L}{H \cdot A}$$

Here, K_{mc} is the wear coefficient, N is the normal force, L is a distance covered, H is the material hardness and A is the contact area.

### Kinematic Model 122.4

The kinematic model 122.4 replicates the movement of the drill segment 16 as a movement in a three-dimensional space.

When the drill bit 10 rotates, the drill segment 16 rotates about an x-axis and moves along an feed direction, similarly to the kinematics of drills.

A cutting rate v_{c} and a feed rate v_{f} can thus be calculated as follows:

$${v}_{c} = π \cdot \frac{n}{60} \cdot d [ \text{m/s} ] \\ and \\ {v}_{f} = n \cdot {a}_{e} ( 2 \text{.2} ) [ cm / min ]$$

where n is the number of revolutions of the drill bit 10 per minute, d is the diameter thereof, and αₑ is a penetration depth per revolution.

A further important parameter of the kinematic model 122.4 describes the passage duration or the time increment tₛ in which the drill segment 16 passes through the workpiece with the material width mw, with the core drill outer radius r_{cb} and the core drill rotational frequency f_{cb}.

This can be based on the following relationship:

$${t}_{s} = \frac{{m}_{w}}{2 π \cdot {f}_{cb} \cdot {r}_{cb}}$$

### Processing Force Model 122.3

The processing force model 122.3 models forces that arise between the drill segment 16 and the respective workpiece during the cutting operation. The forces that act during the cutting process can be modeled on the basis of a fitted Kienzle equation:

$${F}_{ci} = {k}_{c 1.1} \cdot {A}_{i}^{{m}_{c}}$$

where k_{c1.1} is a specific cutting force, A is an orthogonal cutting area and m_{c} is a workpiece material coefficient of the increase in cutting force. These parameters are calculated on the basis of the individual abrasive particles 22 and their interaction with the respective workpiece. The total force acting can be determined by adding up all of the individual forces F_{ci}:

F_{c}=Σᵢ^{nF}_{ci}

The normal force component perpendicular to the cutting direction arises from the cutting force ratio μ, as follows:

$${F}_{n} = \frac{{F}_{c}}{μ} \qquad ( 10 )$$

The specific cutting force k_{c1.1}, the workpiece material coefficient m, and the cutting force ratio μ may be determined experimentally, for example by scratch tests and core drilling tests, and for example by linear regression.

It is hereby thus possible to determine the magnitudes of the forces; the associated force directions can then be determined separately, as discussed below.

### Workpiece Model 122.2

The workpiece model 122.2 models the form of the workpiece and the changes thereto as a result of the cutting process.

In order to model the effect that the abrasive particles 22 have on the workpiece, a cutting profile is firstly determined for each individual abrasive particle 22. As shown in FIG. 9a, the cutting profile is determined from the projected area of the particle 22 parallel to the direction of the cutting speed v_{c}.

The surface of the workpiece that is to be machined, that is to say in the example a concrete or steel surface, is modeled by mesh points.

Within the time increment tₛ, the determined cutting profile is moved with the defined kinematics over the mesh, for example along the arrow shown in FIG. 9a. Along the mesh points that are travelled across, the surface is changed in accordance with the cutting profile, resulting in an updated surface profile of the machine workpiece.

This approach converts a three-dimensional particle into a two-dimensional particle, resulting in a significant reduction of the simulation time for the model.

By comparing the mesh before and after the time increment tₛ, it is furthermore possible to determine the workpiece material volume that has been removed.

With the determined information relating to the cutting profile and the removed volume, the direction of the cutting force can also be determined:

Each surface of a particle 22 can be characterized by normal vectors \vec{nₗ}, which arise from the respective form of the particle 22.

From these normal vectors \vec{nₗ}, it is then possible to derive the direction of the effective total force, and thus the total force vector, by summation:

$$\vec{F} = {\sum }_{i = 1}^{n} \frac{{V}_{i}}{{V}_{t}} \cdot \vec{{n}_{ι}}$$

Here, n corresponds to the total number of surfaces on the abrasive particle 22 in question, Vᵢ corresponds to the volume extracted from the respective surfaces; Vₜ corresponds to the total volume removed in this time increment tₛ. Total volume.

It is conceivable to take yet further effects into consideration. For example, it is conceivable to further improve by integrating thermal and mechanical influences, such as cutting temperature, friction, elastic material behavior, crack propagation or the like.

With the simplifications presented here, the volume of workpiece material removed is dependent on the region of the interaction between the mesh or the workpiece and the cutting profile, and the distance covered. The modeled notching of the workpiece thus corresponds to a negative of the cutting profile. The superposition of the grooves modeled by the notching thus leads to a respective cutting contour with the corresponding surface roughness.

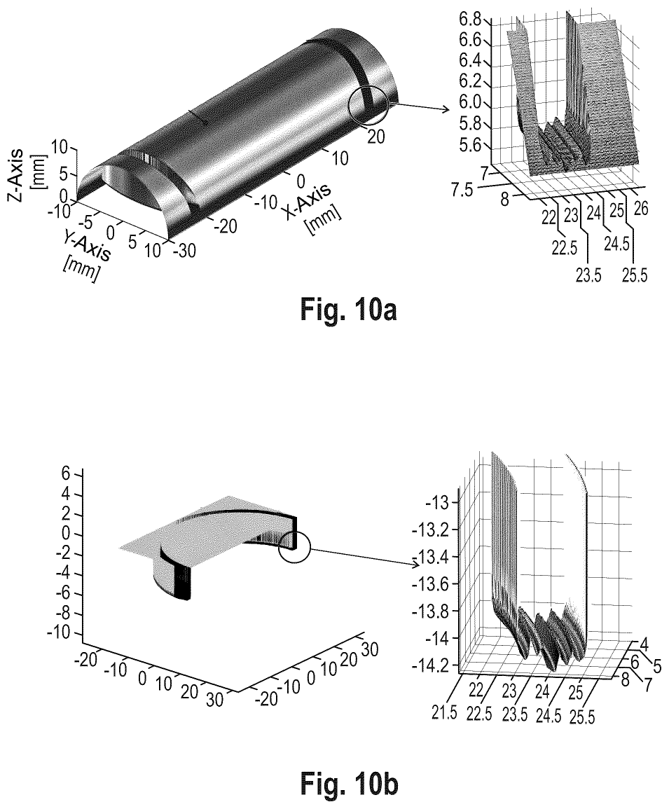

FIG. 10a, for a steel reinforcement, and FIG. 10b, for a concrete element, each show workpieces with modeled cutting contours resulting from the cutting process.

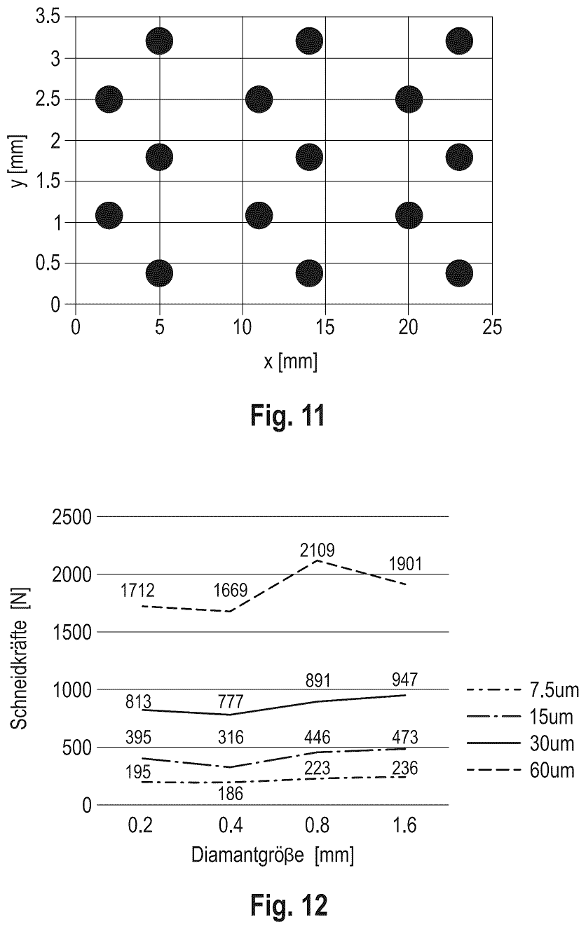

FIG. 11 is a schematic illustration of a pattern for the drill segment 16, which is configured as a diamond drill segment.

The pattern has alternating columns of 3 and 2 diamond abrasive particles 22 respectively.

Measurements of performance parameters such as forces, torques etc. were performed for the drill segment 16 having such a pattern.

The experimentally obtained measurement results were compared with performance parameters obtained from a physical model corresponding to the physical model described above. An altogether very good correlation was observed.

By varying different parameters of the pattern, for example the sizes of the diamond abrasive particles 22, a total of 192 modified patterns were simulated by way of example.

It was possible to identify one pattern with forces that were lower by approximately 20%.

A sample pattern may be regarded here as being identical or at least substantially identical to a comparison pattern if spacings between abrasive particles 22 of the sample pattern deviate by at most 10%, in particular by at most 5%, particularly preferably by at most 1%, from corresponding spacings of the sample pattern. Alternatively or in addition, the two patterns may be regarded as being identical to one another or at least substantially identical to one another if their numbers of abrasive particles 22 deviate from one another by at most 20%, in particular by at most 10%, particularly preferably by at most 5%, very particularly preferably by at most 1%. According to a further conceivable definition of pattern equality, it is alternatively or additionally also possible for characteristics of the abrasive particles 22 to also be taken into consideration. For example, the sample pattern and the comparison pattern may be regarded as being identical or substantially identical if the average particle diameter and/or screen sizes for the screening of the abrasive particles 22 by size differ by at most 20%, in particular by at most 10%, preferably by at most 5%. It is likewise conceivable to take into consideration, as a characteristic of the abrasive particles 22, the occurrence/or a proportion of abrasive particles 22 of a particular shape.

The comparison of patterns of drill segments 16 may preferably relate to the arrangement of the abrasive particles 22 in the respective green products of the respective drill segments 16.

As characteristics of the pattern, it is for example generally conceivable to take into consideration the following:
an average, a most common and/or a maximum particle size, for example a maximum diameter of the abrasive particles, for example in the range from 0.1 to 3 mm, in particular diameters smaller than 0.5 m or greater than 1 mm,
a number of layers, in particular, with regard to FIG. 11, a number of rows, for example between 1 and 20, in particular between 3 and 8,
a concentration ratio between a volume occupied by the abrasive particles 22, and/or an area proportion occupied by said abrasive particles, in relation to the corresponding volume or the corresponding area proportion of the binder material of the drill segment 16, for example in the range between 20% and 80% abrasive particles 22 to binder material,
at least one geometry of the abrasive particles 22, for example the most commonly occurring geometry, in particular prior to the first use of the drill segment 16, and/or
at least one orientation of the abrasive particles 22, for example the most commonly occurring orientation, in particular prior to the first use of the drill segment 16.

FIG. 12 shows a diagram of some of the data obtained from the 192 simulations. In particular, resultant cutting forces are shown in each case for different cutting depths between 7.5 μm and 60 μm and different particle sizes of the diamond abrasive particles 22.

It can be seen that complex dependency relationships were observed, which had a particularly great effect in particular at large cutting depths.

In the example illustrated in FIG. 12, it was for example observed that, for cutting depths of approximately 60 μm, a particle size of the abrasive particles 22 of approximately 0.4 mm can lead to required cutting forces being approximately 20% lower, particular in accordance with 1669/2109, than a particle size of approximately 0.8 mm.

In general, particularly low required forces were thus observed in the case of drill segments 16 with 5 rows (see FIG. 11) and with diamond particles with a maximum diameter in the range from 0.3 mm to 0.6 mm, in particular of 0.4 mm.

### LIST OF REFERENCE SIGNS

10 Drill bit
12 Shaft
14 Connecting section
16 Drill segment
18 Binder material
20 Cutting edge
21 Weld seam
22 Abrasive particles
24 Layer
100 Method
110 Candidate phase
120 Precalculation phase
122 Physical model
122.1 Drill segment model
122.2 Workpiece model
122.3 Processing force model
122.4 Kinematic model
124 Fitted model
130 Selection phase
140 Production phase

1-15. (canceled)

16: A method for manufacturing a drill segment for a drill bit, wherein the drill segment has at least one layer with a multiplicity of abrasive particles, wherein the abrasive particles form a pattern within the layer, the method comprising:
first, precalculating at least one performance parameter of the drill segment with the pattern or determining the pattern according to a precalculation of the performance parameter, and then,
manufacturing the drill segment having the at least one layer with abrasive particles arranged in accordance with the pattern.

17: The method as recited in claim 16 wherein the pattern has at least two similar mutually spaced sub-regions.

18: The method as recited in claim 16 wherein a change of a workpiece to be machined by the drill segment and formed from at least one material is precalculated.

19: The method as recited in claim 16 wherein the workpiece to be machined has at least two materials.

20: The method as recited in claim 16 wherein the workpiece to be machined has stone and metal.

21: The method as recited in claim 16 wherein, for the precalculation, a machine learning module is firstly trained.

22: The method as recited in claim 16 wherein a probabilistic regression is performed.

23: The method as recited in claim 16 wherein an optimum of the performance parameter, or a pattern associated with the optimum of the performance parameter, is determined on the basis of an optimization calculation.

24: The method as recited in claim 16 wherein multiple layers are lined up together in order to form the drill segment or a green body of the drill segment.

25: The method as recited in claim 16 wherein multiple layers are stacked in order to form the drill segment or a green body of the drill segment.

26: The method as recited in claim 16 wherein the at least one performance parameter includes a wear parameter.

27: The method as recited in claim 16 wherein the at least one performance parameter includes a cutting performance parameter.

28: The method as recited in claim 16 wherein the abrasive particles have carbon.

29: The method as recited in claim 16 wherein the abrasive particles have diamond, graphene or carbon nanotubes.

30: The method as recited in claim 16 wherein the abrasive particles have aggregated diamond nanorods or graphene, tungsten carbide, tungsten boride or a boron nitride.

31: The method as recited in claim 16 wherein the manufacturing step occurs when the performance parameter attains or exceeds a particular value,

32: The method as recited in claim 16 wherein the drill bit is a drill bit for machining reinforced concrete.

33: A drill segment for a drill bit, the drill segment comprising:
abrasive particles embedded in a binder material, the drill segment being manufactured in accordance with the method as recited in claim 16.

34: The drill segment as recited in claim 3 wherein the abrasive particles in at least one layer is configured in accordance with a pattern composed of at least two identical, mutually spaced sub-regions.

35: The drill segment as recited in claim 34 wherein the sub-region has at least one polygonal arrangement of abrasive particles.

36: The drill segment as recited in claim 34 wherein the sub-region has at least one triangular or tetragonal, arrangement of abrasive particles.

37: A drill bit comprising:
a shaft having at one end a connecting portion for connecting the drill bit to a power tool, and at an other end at least one drill segment as recited in claim 33.

38: The drill bit as recited in claim 37 wherein the shaft is a tubular shaft.
